(19) United States
(12) Patent Application Publication
(10) Pub. No.: US 2007/0091876 A1
(43) Pub. Date: Apr. 26, 2007

(54) Server apparatus

(75) Inventors: Motohisa Araki, Akishima-shi (JP); Takahiro Izawa, Hachioji-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/584,538

(22) Filed: Oct. 23, 2006

(30) Foreign Application Priority Data
Oct. 25, 2005 (JP) 2005-310131

(51) Int. Cl. H04L 12/66

(52) U.S. Cl. 370/352; 370/401

(57) ABSTRACT

According to one embodiment, a server apparatus includes a memory which stores a management table in which the terminal IDs, the connection IDs, connection positions of the telephone terminals to the first connection network, and pieces of position information representing the connection positions of the connection apparatuses are caused to correspond to each other, and a controller which refers to the management table based on the terminal ID of a telephone terminal serving as a source, when an outgoing request of emergency notification to the second communication network is generated in the telephone terminals, selects a connection apparatus which is closest to the telephone terminal serving as the source based on the reference result, and executes outgoing control from the selected connection apparatus to the second communication network.

### CROSS-REFERENCE TO RELATED APPLICATIONS

This application is based upon and claims the benefit of priority from Japanese Patent Application No. 2005-310131, filed Oct. 25, 2005, the entire contents of which are incorporated herein by reference.

### BACKGROUND

1. Field

One embodiment of the invention relates to a system such as an Internet Protocol (IP) telephone system in which voice communication is performed between telephone terminals through an IP network and, more particularly, to a server apparatus for a communication system in which communication is performed between a telephone terminal connected to an IP network and a telephone terminal connected to a public network.

2. Description of the Related Art

In recent years, a network telephone system (IP telephone system) which interactively transmits and receives images and voices through a packet network as packet data in real time has begun to be popularized. In the IP telephone system, a plurality of IP telephone terminals are housed in an IP network such as a local area network (LAN) or the Internet, and the IP network is connected to a public network through a gateway, and address conversion or the like is performed in the gateway to make it possible to perform multimedia information communication between the IP telephone terminals and between the IP telephone terminals and the public network (for example, Domestic Re-publication of PCT International Publication for Patent Applications No. 98/058475).

However, in the IP telephone system described above, since a position of a source on the IP network is difficult to be specified, emergency notification cannot be made to appropriate facilities.

In a prior art, the following service is conceived. That is, an operator is prepared and accepts an outgoing request of emergency notification from each IP telephone terminal to cope with inquiry or the like from the IP telephone terminal. However, when such a service is to be performed by the operator, the operator which receives an outgoing request gets information about a destination to which the IP telephone terminal wants to make an outgoing call first out of the conversion, and the operator must cause an operator which is responsible for the outgoing area to take over the handling, or the operator must select an appropriate gateway to transfer the outgoing request to the gateway. For this reason, efficiency of processing to an outgoing request of emergency notification is extremely low.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a schematic block diagram showing a communication system according to an embodiment of the invention;

FIG. 2 is a block diagram showing a function of a configuration of a communication server shown in FIG. 1;

FIG. 3 is a diagram showing an example of a storage content of a terminal management database shown in FIG. 2;

FIG. 4 is a diagram showing an example of a storage content of a gateway management database shown in FIG. 2; and

FIG. 5 is a flowchart showing a control procedure of a communication server when outgoing control of emergency notification is performed in the embodiment.

### DETAILED DESCRIPTION

Various embodiments according to the invention will be described hereinafter with reference to the accompanying drawings, In general, according to one embodiment of the invention, a server apparatus which executes communication connection among a plurality of telephone terminals which are connected to a first communication network and a second communication network which is connected to the first communication network through a plurality of connection apparatuses, the telephone terminals to which terminal IDs are allocated, the connection apparatuses to which connection IDs are allocated, the server apparatus comprising: a memory which stores a management table in which the terminal IDs, the connection IDs, connection positions of the telephone terminals to the first connection network, and pieces of position information representing the connection positions of the connection apparatuses are caused to correspond to each other; and a controller which refers to the management table based on the terminal ID of a telephone terminal serving as a source, when an outgoing request of emergency notification to the second communication network is generated in the telephone terminals, selects a connection apparatus which is closest to the telephone terminal serving as the source based on the reference result, and executes outgoing control from the selected connection apparatus to the second communication network.

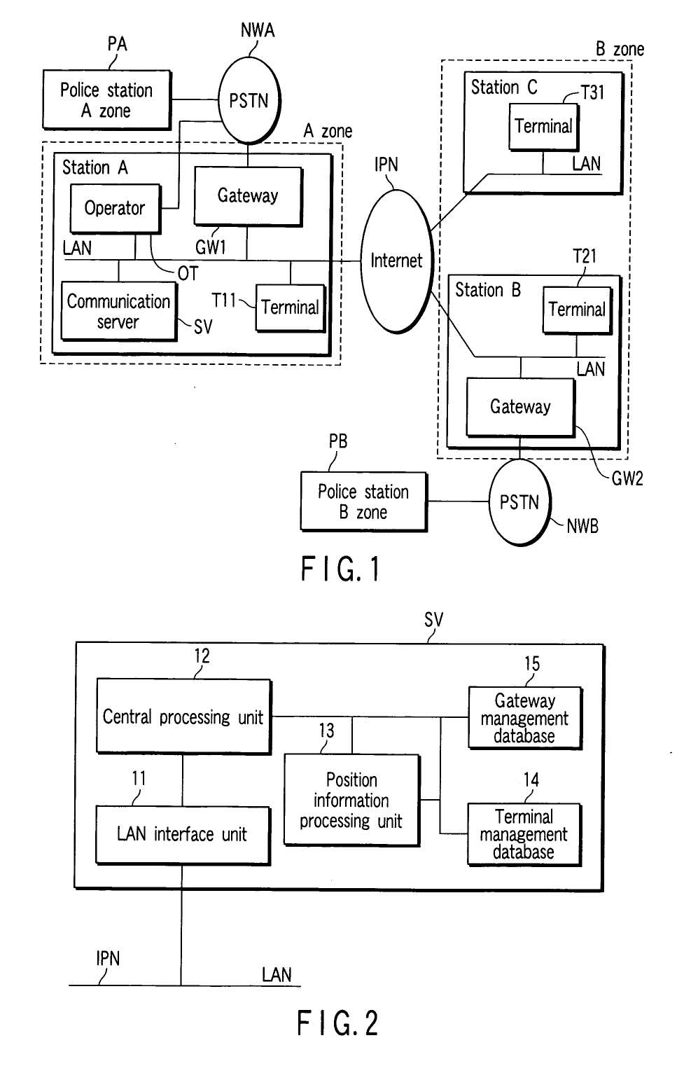

FIG. 1 is a schematic block diagram showing a communication system according to the embodiment of the invention.

This system has an IP network IPN constituted by the Internet for packet communication and a local area network (LAN). The IP network IPN is installed in an station A arranged in A zone and stations B and C arranged in B zone. In The stations A, B, and C, telephone terminals T11, T21, and T31 are connected, respectively. Each of the telephone terminals T11, T21, and T31 is an IP telephone terminal having a speech communication process function and a media information process function.

Gateways GW1 and GW2 serving as connection apparatuses are connected to the IP network IPN. The gateways GW1 and GW2 are to connect the IP network IPN to public networks NWA and NWB, and has a converting function of communication protocols and signal formats between the IP network IPN and the public networks NWA and NWB.

Furthermore, a communication server SV is connected to the IP network IPN. The communication server SV has a switching control function for the telephone terminals T11, T21, and T31 and the gateways GW1 and GW2.

The communication server SV has the following function as a function related to the invention. FIG. 2 is a block diagram showing the configuration of the communication server SV.

More specifically, the communication server SV includes a LAN interface unit 11, a central processing unit 12, a position information processing unit 13, a terminal management database 14, and a gateway management database 15. Of these components, the LAN interface unit 11 is to perform an interface process with the IP network IPN.

The central processing unit 12 is structured to include a CPU, a ROM, and a RAM, and controls the respective components of the communication server SV by software processing.

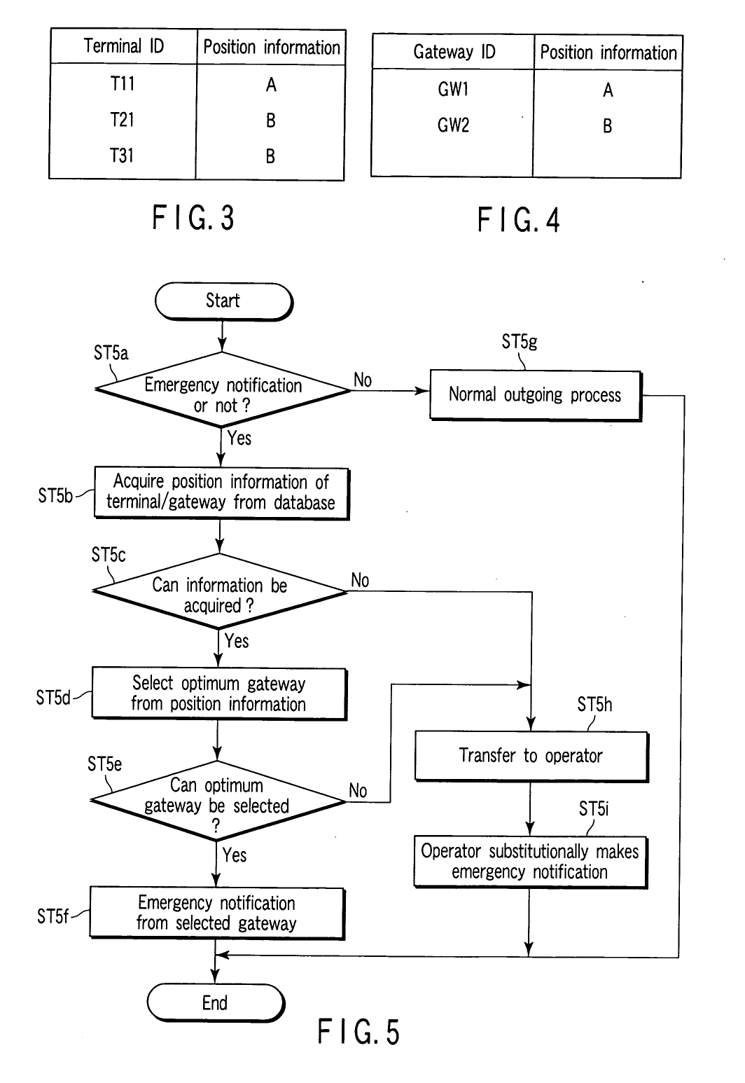

In the terminal management database 14, as shown in FIG. 3, data representing a corresponding relationship among terminal IDs of the telephone terminals T11, T21, and T31 and positional information to which the telephone terminals T11, T21, and T31 belong is stored.

In the gateway management database 15, as shown in FIG. 4, data representing a corresponding relationship between gateway IDs (connection IDs) of the gateways GW1 and GW2 and position information to which the gateways GW1 and GW2 belong is stored.

The position information processing unit 13 reads position information “A” corresponding to the terminal ID of the telephone terminal T11 serving as a source from the terminal management database 14 when an outgoing request of emergency notification from the telephone terminal T11 to the public networks NWA and NWB arrives at the position information processing unit 13. And the position information processing unit 13 compares the read position information “A” with position information in the gateway management database 15 to select a gateway GW1 serving as the position information “A”, and executes outgoing control to the public network NWA through the gateway GW1. These pieces of position information are transmitted from the telephone terminals T11, T21, and T31, a maintenance terminal, or the like and recorded on the terminal management database 14 and the gateway management database 15 through the LAN interface unit 11. The pieces of position information of the gateways GW1 and GW2 are transmitted to the communication server SV when the gateways Gw1 and Gw2 are installed in the IP network IPN.

An operation of the communication system constituted as described above will be described below.

FIG. 5 is a flowchart showing a control procedure of the communication server SV when outgoing control of emergency notification is performed.

It is assumed that a user performs a dial operation of, for example, “110” to make emergency notification in the telephone terminal T31 in the station C. In this case, the outgoing request is transmitted from the telephone terminal T31 to the communication server SV through the IP network IPN.

When the communication server SV receives the outgoing request, the communication server SV analyzes a dial number of a destination included in the outgoing request to determine whether the report is emergency notification based on the analysis result (block ST5a). In this case, since the outgoing request is for emergency notification, the communication server SV reads the position information “B” corresponding to the terminal ID of the telephone terminal T31 included in the outgoing request is read from the terminal management database 14, and the pieces of position information of the gateways GW1 and GW2 are acquired from the gateway management database 15 (block ST5b).

When the pieces of position information of the gateways GW1 and GW2 can be acquired from the gateway management database 15, the communication server SV shifts from block ST5c to block ST5d and compares the pieces of position information with each other to select an optimum one of the gateways GW1 and GT2. In this case, the telephone terminal T31 belongs to B zone, and the gateway GW2 installed in the office B belonging to the same B zone. For this reason, the communication server SV shifts from block ST5e to block ST5f and transmits an outgoing request to the gateway GW2 here to cause the gateway GW2 to perform outgoing to the public network NWB.

In this manner, the emergency notification can be transmitted to a finally appropriate facilities (in this case, a police station PB in B zone).

In block ST5a, when the outgoing request is not for emergency notification, the communication server SV shifts from block ST5a to ST5g to perform a normal outgoing process.

In block ST5c, when position information cannot be acquired from the terminal management database 14 and the gateway management database 15, when the terminal management database 14 and the gateway management database 15 do not respond (out of order), or when an appropriate one of the gateways GW1 and GW2 cannot be selected as a result of comparison between the pieces of position information in block ST5e, the communication server SV transfers an outgoing request to an operator terminal OT to cause the operator terminal OT to perform substitutional outgoing to the public networks NWA and NWB (block ST5h and block ST5i).

As described above, in the embodiment, when an outgoing request for emergency notification from the telephone terminal T31 to the public networks NWA and NWB arrives at the communication server SV, position information “B” of a source is read from the terminal management database 14 based on a terminal ID of the source included in the outgoing request. The position information “B” is compared with the pieces of position information of the gateways GW1 and GW2 in the gateway management database 15, and the closest gateway GW2 is selected based on the comparison result, so that the emergency notification is transmitted from the gateway GW2 to the public network NWB.

Therefore, the optimum gateways GW1 and GW2 used when emergency notification is transmitted from the telephone terminals T11, T21, and T31 on the IP network IPN to the public networks NWA and NWB can be specified, so that transmission of the emergency notification to appropriate facilities can be efficiently performed.

In the embodiment, in the communication server SV, when position information is input in an active state of, for example, the telephone terminal T11, the terminal ID and the position information of the telephone terminal T11 can be automatically acquired and registered without causing an operator to manually perform a registering process in the terminal management database 14.

Furthermore, in the embodiment, in the communication server SV, if the pieces of position information of the telephone terminals T11, T21, and T31 of the source or the position information of the gateways GW1 and GW2 for outgoing cannot be acquired due to failure or the like, an outgoing request for emergency notification is transferred to the operator terminal OT. For this reason, substitutional outgoing to appropriate facilities can be reliably performed by the operator.

The invention is not limited to the above embodiment. For example, the embodiment explains an example in which an IP telephone terminal is used as a telephone terminal. However, in addition to the IP telephone terminal, a terminal using a wireless LAN or a software phone realized by software on a personal computer may be used.

In addition, the configuration and type of system, the configuration and the type of the communication server, type of extension terminal, type of data terminal, the storage contents of the various tables, the selective control method of the gateways, and the like can be variously changed and modified without departing from the spirit and scope of the invention.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A server apparatus which executes communication connection among a plurality of telephone terminals which are connected to a first communication network and a second communication network which is connected to the first communication network through a plurality of connection apparatuses, the telephone terminals to which terminal IDs are allocated, the connection apparatuses to which connection IDs are allocated, the first communication network for transmitting communication packets, the server apparatus comprising:
a memory which stores a management table in which the terminal IDs, the connection IDs, connection positions of the telephone terminals to the first connection network, and pieces of position information representing the connection positions of the connection apparatuses are caused to correspond to each other; and
a controller which refers to the management table based on the terminal ID of a telephone terminal serving as a source, when an outgoing request of emergency notification to the second communication network is generated in the telephone terminals, selects a connection apparatus which is closest to the telephone terminal serving as the source based on the reference result, and executes outgoing control from the selected connection apparatus to the second communication network.

2. The server apparatus according to claim 1, further comprising:
a acquiring unit to acquire the terminal ID of the telephone terminal and the position information, to record the terminal ID and the position information on the management table, when position information is input in an active state of the connection apparatus to the telephone terminal.

3. The server apparatus according to claim 2, wherein the acquiring unit acquires the connection ID of the connection apparatus and the position information and records the connection ID and the position information on the management table in an active state of the connection apparatus to the first communication network.

4. The server apparatus according to claim 1, further comprising:
an interface which connects a operator terminal which receives an outgoing request of the emergency notification, and executes substitutional outgoing,
wherein the controller transfers the outgoing request to the operator terminal, when the position information of the telephone terminal serving as the source or the position information of the connection apparatus for outgoing cannot be acquired from the reference result of the management table.
